(19) United States
(12) Patent Application Publication
(10) Pub. No.: US 2014/0110056 A1
(43) Pub. Date: Apr. 24, 2014

(54) METHOD FOR MANUFACTURING IMAGE DISPLAY DEVICE

(71) Applicants: Toshihiro Suwa, Kanagawa Pref. (JP); Yasuhiro Kinoshita, Kanagawa Pref (JP); Hikaru Takeda, Hachioji-city, Tokyo (JP)

(72) Inventors: Toshihiro Suwa, Kanagawa Pref. (JP); Yasuhiro Kinoshita, Kanagawa Pref (JP); Hikaru Takeda, Hachioji-city, Tokyo (JP)

(73) Assignee: 3M INNOVATIVE PROPERITIES COMPANY, St. Paul, MN (US)

(21) Appl. No.: 14/009,914

(22) PCT Filed: Apr. 4, 2012
(86) PCT No.: PCT/US12/32035

§ 371 Date: Dec. 6, 2013

(30) Foreign Application Priority Data
Apr. 8, 2011 (JP) 2011-086146

(51) Int. Cl. G09G 3/36

(52) U.S. Cl. CPC G09G 3/36
USPC 156/315; 156/327; 156/332

(57) ABSTRACT

A method for manufacturing an image display device includes: providing an image display unit having an image display surface; providing a translucent protective material having a light-shielding portion; disposing a liquid optically clear adhesive (LOCA) between the image display surface of the image display unit and the translucent protective material; and curing the LOCA to adhere the image display unit with the translucent protective material. The LOCA is a two-part redox-type adhesive composed of a first composition including a first base agent containing a compound having at least one ethylenically unsaturated group and a polymerization initiator and a second composition including a second base agent containing a compound having at least one ethylenically unsaturated group and a reducing agent capable of decomposing the polymerization initiator.

### TECHNICAL FIELD

The present invention relates generally to a method for manufacturing an image display device. In particular, the present invention includes adhering a protective material to an image display unit by using a two-part adhesive.

### BACKGROUND

A sheet-like protective material formed by a glass plate or a plastic film is laminated on a display panel of an electronic device, such as a cellular phone or a computer, or an optical unit, such as a touch panel. Such a protective material is fixed on the display panel by applying tape or adhesive to the marginal area outside of the image display area of the display. This approach creates a gap between the protective material and the display panel. The optical performance of the display can be improved by decreasing the number of surfaces for internal reflection, and therefore it is preferable to eliminate the gap between the display panel and the protective material.

In recent years, a gap between a display panel and protective material is generally filled with a transparent material because higher light transmittance and a clearer image are obtained. As the transparent material, both a transfer adhesive tape and an ultraviolet-curable liquid adhesive are currently being used. In particular, an ultraviolet-curable liquid optically clear adhesive (hereinafter, referred to as LOCA in the present specification) is most commonly used as the transparent material for the application to a large display. In the adhesion system using LOCA, first, an ultraviolet-curable liquid is coated on a display by using a dispenser. Next, a glass plate or a plastic sheet is laminated thereon, and then ultraviolet radiation is irradiated through the glass plate or plastic sheet.

The protective material sometimes has a printed area (usually black) on the surface for the purpose of light shielding or display design. In this case, the light is blocked by the printed area, and therefore it is very difficult to cure LOCA by irradiation of ultraviolet rays (or a visible ray). In order to improve curing below the printed area, lateral irradiation of light is carried out. However, when the printed area has a large width (for example, a width of 50 mm), lateral irradiation of light may fail in effecting sufficient curing even in the deep part. If the curing below the printed area is insufficient, the LOCA may develop separation or cohesive failure from the insufficiently cured portion or image unevenness may be generated due to non-uniform internal stress of the transparent material in the display plane. Furthermore, the apparatus for performing both ultraviolet irradiation from the perpendicular direction and ultraviolet irradiation from the lateral side is complicated and very expensive.

International Publication No. WO 2007/066590 describes an indicator fabricated by full-surface lamination of a transparent cover plate or touch panel and a liquid crystal display device and free from color unevenness and separation, where the hardness of the optical adhesive adhering the transparent cover plate or touch panel to the liquid crystal display device is from 1 to 30 in terms of the Shore A hardness and the thickness of the adhesive layer is from 30 to 200 μm.

International Publication No. WO 2008/123551 describes “A method for manufacturing an image display device (1), comprising steps of interposing a photocurable resin composition (11) between a base (2) having an image display part, such as a liquid crystal display panel (8), and a translucent protective part (3) having a light-shielding portion (5), and photocuring the composition to form a resin cured layer (15), wherein a resin composition (11) having a cure shrinkage percentage of 5% or less, giving a cured product with a storage modulus of 1.0×10⁷ Pa or less at 25° C., and allowing the resin cured layer (15) to exhibit a light transmittance of 90% or more in the visible region is used as the photocurable resin composition (11). Furthermore, steps of interposing a thermopolymerization initiator-containing curable resin composition (11a) at least between the light-shielding portion (5) and the base (2) and heating the curable resin composition (11a) are provided. Due to these configurations, in manufacturing a thin image display device (1) where a resin is interposed between the protective part (3) having a light-shielding portion (5) and the image display part (8), high-luminance high-contrast display can be realized without causing a display failure due to deformation of the image display part (1), and at the same time, the resin in the formed region of the light-shielding portion (5) can also be sufficiently cured.”

### SUMMARY

This disclosure provides a method for more complete curing of a liquid optically clear adhesive in the region corresponding to a light-shielding portion when adhering a translucent protective material having a light-shielding portion, such as a printed area, to an image display unit, such as a liquid crystal display.

According to one embodiment of this disclosure, there is provided a method for manufacturing an image display device. The method includes providing an image display unit having an image display surface, providing a translucent protective material having a light-shielding portion, disposing a liquid optically clear adhesive between the image display surface of the image display unit and the translucent protective material, and curing the liquid optically clear adhesive to adhere the image display unit with the translucent protective material. The liquid optically clear adhesive is a two-part redox-type adhesive composed of: a first composition comprising a first base agent containing a compound having at least one ethylenically unsaturated group and a polymerization initiator; and a second composition comprising a second base agent containing a compound having at least one ethylenically unsaturated group and a reducing agent capable of decomposing the polymerization initiator.

According to this disclosure, uniform adhesion can be achieved in the entire surface of the region applied with a liquid optically clear adhesive, including the region corresponding to a light-shielding portion, so that generation of image unevenness can be suppressed. In addition, according to this disclosure, separation of a protective material from a light-shielding portion can be prevented.

Incidentally, the description above should not be construed as disclosing all embodiments of the present invention and all advantages relevant to the present invention.

### BRIEF DESCRIPTION OF THE DRAWINGS

FIG. 1 is a schematic view showing a procedure of disposing LOCA according to one embodiment of this disclosure.

FIG. 2 is a schematic view showing a procedure of disposing LOCA according to another embodiment of this disclosure.

FIG. 3 is a schematic view showing a procedure of disposing LOCA according to still another embodiment of this disclosure.

FIG. 4A is a plan view of a cover sheet used in the Examples.

FIG. 4B is a side view of the cover sheet used in the Examples.

FIG. 5 is a side view showing a cover sheet, a release-treated glass plate, and a LOCA disposed therebetween.

FIG. 6 is a schematic view of a tensile test performed in the Examples.

### DETAILED DESCRIPTION

The present invention is described below in more detail for the purpose of illustrating representative embodiments of the present invention, and the present invention is not limited to these embodiments.

In the present specification, the term “redox polymerization” means a polymerization reaction that proceeds using a radical generated by an oxidation-reduction reaction between a polymerization initiator and a reducing agent.

The term “(meth)acryl” means “acryl” or “methacryl”, and the term “(meth)acrylate” means “acrylate” or “methacrylate.”

The term “storage modulus” means a storage modulus (Pa) at a designated temperature when the viscoelasticity is measured in a shear mode at a temperature rising rate of 5° C./min and a frequency of 1 Hz in a temperature range from −60° C. to 200° C.

The method for manufacturing an image display device of this disclosure includes providing an image display unit having an image display surface, providing a translucent protective material having a light-shielding portion, disposing a liquid optically clear adhesive between the image display surface of the image display unit and the translucent protective material, and curing the liquid optically clear adhesive to adhere the image display unit with the translucent protective material. The liquid optically clear adhesive is a two-part redox-type adhesive composed of a first composition containing a first base agent and a polymerization initiator and a second composition containing a second base agent and a reducing agent capable of decomposing the polymerization initiator.

Examples of the image display unit include, but are not limited to: a liquid crystal display unit, an organic EL display unit, an LED display unit and a plasma display unit. The image display unit can be incorporated into, for example, an electronic device, such as a cellular phone or a computer, or an optical unit, such as a touch panel. Such an image display unit has an image display surface composed of an image display area and its marginal area.

The translucent protective material is a sheet-like material covering the entirety or a part of the image display surface of the image display unit, and for example, a glass plate formed from an optical glass, or a plastic film, such as acrylic resin, may be used. In view of manufacturing cost, impact resistance and the like, a plastic film, particularly a polymethyl methacrylate (PMMA) film, can be advantageously used. The thickness of the translucent protective material is generally from about 188 μm to about 3 mm, and the light transmittance is generally about 85% or more, particularly about 90% or more, over the wavelength region from 460 to 720 nm.

The translucent protective material has a light-shielding portion, for example, in an area corresponding to the marginal area of the image display unit. The light-shielding portion is generally formed on the translucent protective material surface facing the image display unit by printing or by laminating a light-shielding tape. In addition, the light-shielding portion is generally formed like a black frame surrounding the image display area of the image display unit. For example, the light-shielding portion is frame-shaped. The frame width is generally from about 1 mm to about 100 mm, and according to this disclosure, even when manufacturing a large image display device with the frame-shaped light-shielding portion having a large frame width of, for example, about 10 mm or more, the liquid optically clear adhesive below the light-shielding portion can be sufficiently cured.

The liquid optically clear adhesive (LOCA) disposed between the image display surface of the image display unit and the translucent protective material is a two-part redox-type adhesive that is composed of a first composition containing a first base agent and a polymerization initiator and a second composition containing a second base agent and a reducing agent and is cured by redox polymerization occurring when the first composition and the second composition are mixed. The redox polymerization is a polymerization reaction utilizing the fact that when a reducing agent is allowed to coexist with a polymerization initiator, the activation energy of decomposition reaction of the polymerization initiator is reduced and an active radical is readily generated even at ordinary temperature. Accordingly, in the method of this disclosure, LOCA can be cured without requiring heating and/or irradiation of light, such as ultraviolet rays.

The first composition includes a first base agent containing a compound having at least one ethylenically unsaturated group (for example, a (meth)acrylic compound or a vinyl compound such as divinyl phthalate, divinyl succinate and diallyl phthalate), and a polymerization initiator. As the compound having at least one ethylenically unsaturated group, in view of optical characteristics, adhesive force and the like, a (meth)acrylic monomer, a (meth)acrylic oligomer and a (meth)acrylic polymer can be advantageously used. Examples of the (meth)acrylic monomer include, but are not limited to: a monofunctional (meth)acrylic monomer, such as (meth)acrylic acid, methyl (meth)acrylate, ethyl (meth)acrylate, butyl (meth)acrylate, 2-ethylhexyl (meth)acrylate, lauryl (meth)acrylate, tridecyl (meth)acrylate, 2-hydroxyethyl (meth)acrylate, 2-hydroxypropyl (meth)acrylate, 4-hydroxybutyl (meth)acrylate, isobornyl (meth)acrylate, tetrahydrofurfuryl (meth)acrylate, dimethylaminoethyl (meth)acrylate, 2-(meth)acryloyloxyethyl acid phosphate; and a polyfunctional (meth)acrylic monomer, such as methylenebis(meth)acrylamide, 1,6-hexamethylenebis(meth)acrylamide, diethylenetriaminetris(meth)acrylamide, ethylene glycol di(meth)acrylate, 1,4-butanediol di(meth)acrylate, 1,6-hexanediol di(meth)acrylate, ethoxyethoxyethyl (meth)acrylate, glycerol di(meth)acrylate, glycerol tri(meth)acrylate, trimethylolpropane tri(meth)acrylate, pentaerythritol tri(meth)acrylate and pentaerythritol tetra(meth)acrylate. Examples of the (meth)acrylic oligomer and (meth)acrylic polymer include a monofunctional (meth)acrylate oligomer or polymer, such as polyethylene glycol (meth)acrylate and polypropylene glycol (meth)acrylate; a polyfunctional (meth)acrylate oligomer or polymer, such as polyfunctional polyether (meth)acrylate (e.g., polyethylene glycol di(meth)acrylate), polyfunctional urethane (meth)acrylate and polyfunctional polyester (meth)acrylate; a terminal (meth)acryl-modified liquid polybutadiene, and a terminal (meth)acryl-modified liquid polyisoprene. The kind and amount of the compound having at least one ethylenically unsaturated group is selected so that the first composition and the cured LOCA can have desired properties (for example, viscosity, cure shrinkage percentage and storage modulus). One of these compounds may be used alone as the first base agent, or a combination of two or more thereof may be used as the first base agent. A syrup prepared by partially polymerizing a (meth)acrylic monomer in advance may also be used. In particular, in the manufacture of a large image display device, the first base agent preferably contains a (meth)acrylic oligomer or a (meth)acrylic polymer, because the cure shrinkage and internal stress of LOCA after curing tend to be small.

The polymerization initiator usable in the method of this disclosure includes, but is not limited to: an organic peroxide, an inorganic peroxide and an azo compound, which are generally used as a radical polymerization initiator. In view of storage stability, the cleavage temperature of the polymerization initiator itself in the absence of a reducing agent is advantageously from about 80° C. to about 120° C. Examples of the organic peroxide include, but are not limited to: benzoyl peroxide, methyl ethyl ketone peroxide, cumene hydroperoxide and tert-butyl peroxybenzoate; examples of the inorganic peroxide include hydrogen peroxide, potassium persulfate and ammonium persulfate; and examples of the azo compound include 2,2′-azobis(4-methoxy-2,4-dimethylvaleronitrile), 2,2′-azobis(2,4-dimethylvaleronitrile), 2,2′-azobisisobutyronitrile and 2,2-azobis[2-(2-imidazolin-2-yl)propane]dihydrochloride. Among these, an organic peroxide can be advantageously used because of its high curing speed, and in view of curing speed and storage stability, cumene hydroperoxide and tert-butylperoxy benzoate can be more advantageously used. One of these may be used alone, or two or more thereof may be used in combination. The polymerization initiator can be used in a ratio of about 0.1 mass % to about 5 mass % based on the mass of the first composition.

The second composition includes a second base agent containing a compound having at least one ethylenically unsaturated group and a reducing agent capable of decomposing the polymerization initiator. The kind and amount of the compound having at least one ethylenically unsaturated group, contained in the second base agent, may be the same as those of the compound contained in the first base agent. The second base agent may be the same as or different from the first base agent. In the case where the first base agent and the second base agent are the same, this is advantageous in view of mixability of two compositions and uniformity of the cured product.

The reducing agent which can be used in the method of this disclosure includes, for example, an organic amine, an organic thiourea, an organic acid metal salt, an organic metal chelate compound, a metal sulfide or a metal oxide. Examples of the organic amine include, but are not limited to: triethylamine, tripropylamine, tributylamine, N,N-dimethylaniline, N,N-diethylaniline and N,N-dimethyltoluidine. Examples of the organic thiourea include, but are not limited to: methylthiourea, diethylthioura, acetylthiourea, tetramethylthiourea and ethylenethiourea. Examples of the organic acid metal salt include, but are not limited to: copper acetate, copper 2-ethylhexanoate, cobalt 2-ethylhexanoate, copper naphthenate, cobalt naphthenate, vanadium naphthenate, manganese naphthenate, nickel naphthenate and iron naphthenate. Examples of the organic metal chelate compound include, but are not limited to: vanadyl acetylacetonate, titanium acetylacetonate and copper acetylacetonate. Examples of the metal sulfide include, but are not limited to: copper sulfide, cobalt sulfide, manganese sulfide, nickel sulfide and iron sulfide. A example of the metal oxide includes, but is not limited to, copper oxide. Among these, an organic amine, an organic thiourea, an organic acid metal salt and an organic metal chelate compound can be advantageously used. One of these may be used alone, or two or more thereof may be used in combination. In one embodiment, the reducing agent can be used in a ratio of about 0.05 mass % to about 5 mass % based on the mass of the second composition. In the case where the second composition is applied to a region corresponding to the image display area, a reducing agent causing less discoloration attributable to the reducing agent is particularly selected.

Each of the first composition and the second composition may further contain optional components, such as a plasticizer, tackifier, spacer, non-absorbing inorganic oxide, silane coupling agent or polymerization inhibitor.

The plasticizer can be added to the first composition and/or the second composition for enhancing the softness and flexibility of the cured LOCA. The plasticizer includes a plasticizer generally used for synthetic rubber, such as bis(2-ethylhexyl) adipate, and an oil such as vegetable oil or mineral oil. One of these may be used alone, or two or more thereof may be used in combination. In one embodiment, the amount of the plasticizer may be generally about 0.1 mass % or more, or about 1 mass % or more, and about 20 mass % or less, or about 10 mass % or less, based on the total mass of the first composition and the second composition.

A tackifier can be added to the first composition and/or the second composition for increasing the tack strength of the cured LOCA. Examples of the tackifier include, but are not limited to: a rosin (pine resin) such as wood rosin, gum rosin and tall rosin, a hydrocarbon resin obtained from a petroleum-based raw material, and a terpene resin derived from a terpene raw material of tree or fruit. In one embodiment, the amount of the tackifier may be generally about 0.01 mass % or more, or about 0.1 mass % or more, and about 20 mass % or less, or about 10 mass % or less, based on the total mass of the first composition and the second composition.

The spacer may be a bead-shaped ceramic, glass, silicate, polymer or plastic and can be added to the first composition and/or the second composition for setting the cured LOCA layer to a specific thickness. In one embodiment, the spacer is substantially spherical and the diameter thereof is about 1 μm or more, or about 50 μm or more, and about 5 mm or less, or about 1 mm or less.

The non-absorbing inorganic oxide is a material substantially transparent in the visible region and can be added to the first composition and/or the second composition for modifying the refractive index of the cured LOCA. The non-absorbing inorganic oxide includes Al₂O₃, ZrO₂, TiO₂, V₂O₅, ZnO, SnO₂, ZnS, SiO₂ and a mixture thereof. The non-absorbing inorganic oxide may be subjected to a surface treatment such as silane treatment so as to enhance the dispersibility in the composition. The non-absorbing inorganic oxide is generally in the form of a particle having an average particle diameter of about 1 nm to about 100 nm and can be added in an amount within the range not impairing the optical properties of the cured LOCA.

Each of the first composition and the second composition has a viscosity suitable for effective manufacture of the objective image display device, and the viscosity of the composition can be suitably determined according to the apparatus used for applying the composition. For example, when measured at a temperature of 25° C. and a shear rate of 1 second⁻¹, the viscosity of the first composition and the second composition may be about 100 mPa·s or more, about 200 mPa·s or more, or about 1,000 mPa·s or more, and about 10,000 mPa·s or less, about 8,000 mPa·s or less, or about 5,000 mPa·s or less.

The LOCA composed of the above-described first composition and second composition can be disposed between the image display surface of the image display unit and the translucent protective material by conventionally known methods, for example, by dispensing, slot die extrusion or printing (e.g., screen printing, stencil printing). For example, the first composition and the second composition may be separately filled in a conventionally known cartridge for two-part adhesives, the first composition and the second composition may be mixed through a mixing nozzle fixed to the cartridge end, and the mixture may be dispensed from the nozzle tip to the image display surface of the image display unit or the surface of the translucent protective material. The thickness of LOCA after curing can be determined to be large enough to adhere the image display unit with the translucent protective material. For example, a mixture of the first composition and the second composition may be applied so that the thickness of LOCA after curing can be from about 50 μm to about 400 μm.

Instead of mixing the first composition and the second composition of LOCA, respective compositions may be applied to the image display surface of the image display unit and/or the surface of the translucent protective material, and the image display unit and the translucent protective material may be positioned adjacent to one another such that the first and second compositions contact one another and mix together, thereby allowing the redox polymerization of LOCA to proceed. In this embodiment, the first composition and the second composition are not cured until they contact one another and mix together. Therefore, the pot lives of these compositions need not be taken into account, and the flexibility of the manufacturing process can be improved. Furthermore, since curing starts upon contact/mixing, an open time required in the case of a rubber-based adhesive or a hot-melt adhesive can be omitted and the tact time of the manufacture can be shortened.

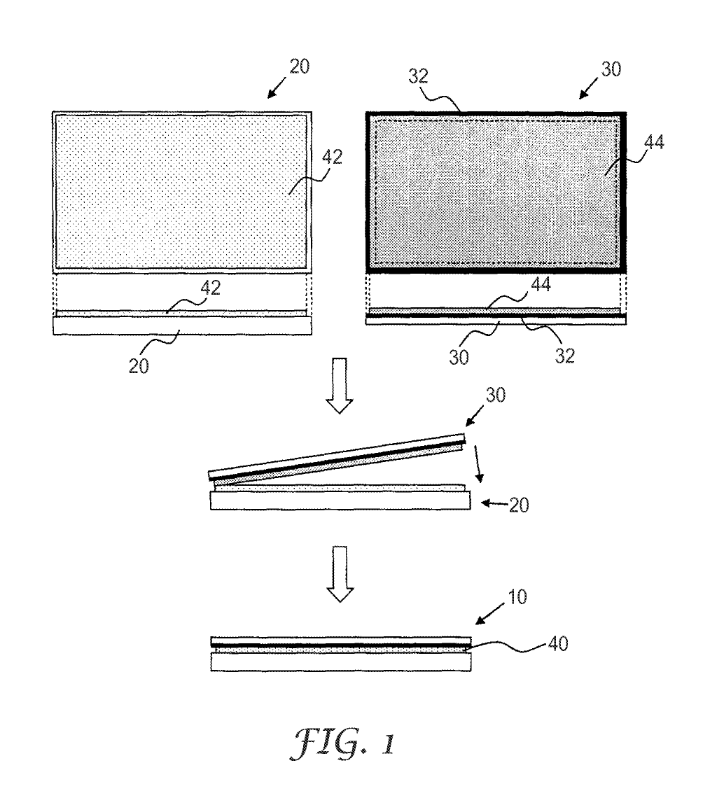

FIG. 1 schematically shows the procedure of disposing LOCA according to one embodiment of this disclosure, where first composition 42 is applied to the image display surface of image display device 20 by slot die extrusion, printing or the like (left side, top diagram of FIG. 1; the upper is plan view and the lower is side view). On the other hand, second composition 44 is applied to the surface of translucent protective material 30 having frame-shaped light-shielding portion 32, that is, in FIG. 1, the surface where light-shielding portion 32 is formed by printing or the like (right side, top diagram of FIG. 1; the upper is plan view and the lower is side view). It is also possible to apply the first composition to the surface of the translucent protective material and apply the second composition to the image display surface of the image display device (not shown in FIG. 1).

Next, image display unit 20 and translucent protective material 30 are positioned by arranging the image display surface, that is, the surface applied with first composition 42 of image display unit 20 to face the surface applied with second composition 44 of translucent protective material 30 (the middle diagram of FIG. 1, side view). FIG. 1 shows how image display unit 20 and translucent protective material 30 are aligned at one edge and translucent protective material 30 is gradually lowered so that the contact portion of the first composition and the second composition can increase in the direction perpendicular to the edge. By this procedure, first composition 42 and second composition 44 are contacted and at least partially mixed. In this way, LOCA 40 is disposed between the image display surface of image display unit 20 and translucent protective material 30 (the lower diagram of FIG. 1, side view).

The application thicknesses of the first composition and the second composition can be suitably determined so that LOCA after curing can have a thickness large enough to adhere the image display unit with the translucent protective material. For example, the first composition and the second composition can be applied so that the thickness of LOCA after curing can be from about 50 μm to about 400 μm, and each of the first composition and the second composition can be applied to a thickness of, for example, from about 15 μm to about 350 μm. In one embodiment, the thickness of the second composition is about 10% or less, or about 20% or less, of the thickness of the first composition. In another embodiment, the thickness of the first composition is about 10% or less, or about 20% or less, of the thickness of the second composition.

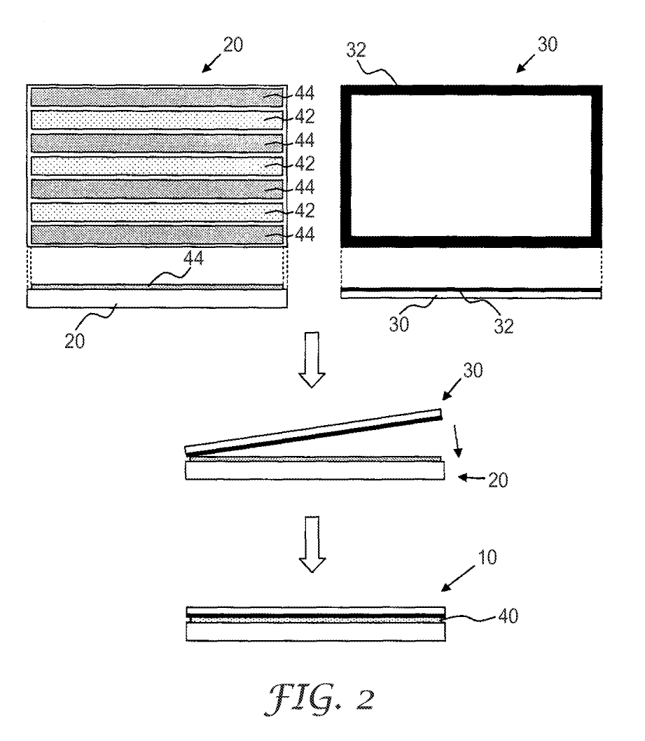

FIG. 2 schematically shows the procedure of disposing LOCA according to another embodiment of this disclosure. In this case, first composition 42 and second composition 44 are alternately applied in a striped fashion to the image display surface of image display unit 20 by dispensing, slot die extrusion or the like (left side, top diagram of FIG. 2; the upper is plan view and the lower is side view). It is also possible to alternately apply the first composition and the second composition in a striped fashion to the surface of the translucent protective material (not shown in FIG. 2).

Next, image display unit 20 and translucent protective material 30 are positioned by arranging the image display surface, that is, the surface applied with first composition 42 and second composition 44, of image display unit 20 to face the surface of translucent protective material 30 (in FIG. 2, the surface having light-shielding portion 32 formed by printing or the like) (the middle diagram of FIG. 2, side view). FIG. 2 shows how image display unit 20 and translucent protective material 30 are aligned and translucent protective material 30 is gradually lowered so that the first composition and the second composition adjacent thereto can come into contact in the longitudinal direction of stripes of the first composition and the second composition. In this embodiment, a gap provided between the stripes of the first composition and the second composition functions as an exhaust pathway for allowing any air present between the image display unit and the translucent protective material to be removed during the lamination, so that mixing of air bubbles in LOCA can be effectively prevented. By this procedure, each of first composition 42 and second composition 44 is spread. As a result, the first composition and the second composition are brought into contact with each other and at least partially mixed. In this way, LOCA 40 is disposed between the image display surface of image display unit 20 and translucent protective material 30 (the lower diagram of FIG. 2, side view).

The application thicknesses of the first composition and the second composition can be suitably determined so that LOCA after curing can have a thickness large enough to adhere the image display unit with the translucent protective material. For example, the first composition and the second composition can be applied so that the thickness of LOCA after curing can be from about 50 μm to about 400 μm, and the thickness of each of the first composition and the second composition can be, for example, from about 50 μm to about 400 μm. Each of the first composition and the second composition can be applied to a width of, for example, from about 1 mm to about 10 mm. The distance between adjacent first and second compositions can be, for example, from about 2 mm to about 10 mm.

In this way, the first composition and the second composition are at least partially mixed, whereby curing of LOCA by redox polymerization proceeds, and in turn, the image display unit and the translucent protective material are adhered. LOCA is generally cured at room temperature for 10 minutes to 24 hours and thereby provides an adhesive force having sufficiently high strength. LOCA of this disclosure does not particularly require heating as in the conventional heat curing reaction, but may be heated, for example, at about 50° C. to about 100° C., so as to accelerate the curing reaction.

LOCA after curing preferably exhibits little or no shrinkage. For example, the shrinkage percentage of LOCA after curing is preferably about 5% or less. LOCA after curing may have a soft area with a Shore A hardness of about 30 or less, about 20 or less, or about 10 or less. The storage modulus of LOCA after curing may be about 1×10² Pa or more, or about 1×10³ Pa or more, and about 1×10⁷ Pa or less, or about 1×10⁶ Pa or less.

LOCA after curing has a light transmittance suitable for the objective usage. For example, LOCA after curing may have a light transmittance of about 85% or more over the wavelength region from 460 to 720 nm. The light transmittance per thickness of 1 mm of LOCA after curing may be about 85% or more at 460 nm, about 90% or more at 530 nm, and about 90% at 670 nm. Such light transmission properties are advantageous to uniformly transmit light over the entire visible region when the image display device contains a full color display unit. The refractive index of LOCA after curing is preferably equal or close to the refractive index of the image display surface of the image display unit and/or the translucent protective material (for example, from about 1.4 to about 1.7).

The first composition and/or the second composition may further contain a photopolymerization initiator. In this embodiment, both reactions of photopolymerization and redox polymerization can be allowed to proceed in parallel by irradiating light, such as ultraviolet rays. When light is irradiated, LOCA in the light-irradiated portion is rapidly cured, and therefore, in this embodiment, the protective material can be temporarily fixed to the image display unit. In addition, the redox polymerization proceeds even after light irradiation, for example, during storage of the product in a dark place, and therefore, the light irradiation time can be shorter than in the normal curing process only by photopolymerization, so that reduction in the tact time and power saving can be achieved when manufacturing. Examples of the photopolymerization initiator include, but are not limited to: benzophenone, 4-phenylbenzophenone, benzyl, benzoin, benzoyl isopropyl ether, benzoylbenzoic acid, 2,2-diethoxyacetophenone, bis(diethylamino)benzophenone, benzyl dimethyl ketal, 1-hydroxycyclohexylphenyl ketone, thioxanthone, 1-(4-isopropylphenyl)-2-hydroxy-2-methylpropan-1-one, 1-(4-(2-hydroxyethoxy)phenyl)-2-methyl-1-propan-1-one, 2-hydroxy-2-methyl-1-phenylpropan-1-one, camphorquinone, 2,2-dimethoxy-1,2-diphenylethan-1-one, ethyl-2,4,6-trimethylbenzoylphenylphosphinate, 2,4,6-trimethylbenzoyldiphenylphosphine oxide, bis(2,4,6-trimethylbenzoyl)phenylphosphine oxide, 2-methyl-1-(4-(methylthio)phenyl)-2-morpholinopropan-1-one, 2-benzyl-2-dimethylamino-1-(4-morpholinophenyl)-1-butan-1-one and bis(2,6-dimethoxybenzoyl)-2,4,4-trimethyl-pentylphosphine oxide. One of these may be used alone, or two or more thereof may be used in combination. In one embodiment, the photopolymerization initiator can be used in a ratio of about 0.1 mass % to about 5 mass % based on the total mass of the first composition and the second composition.

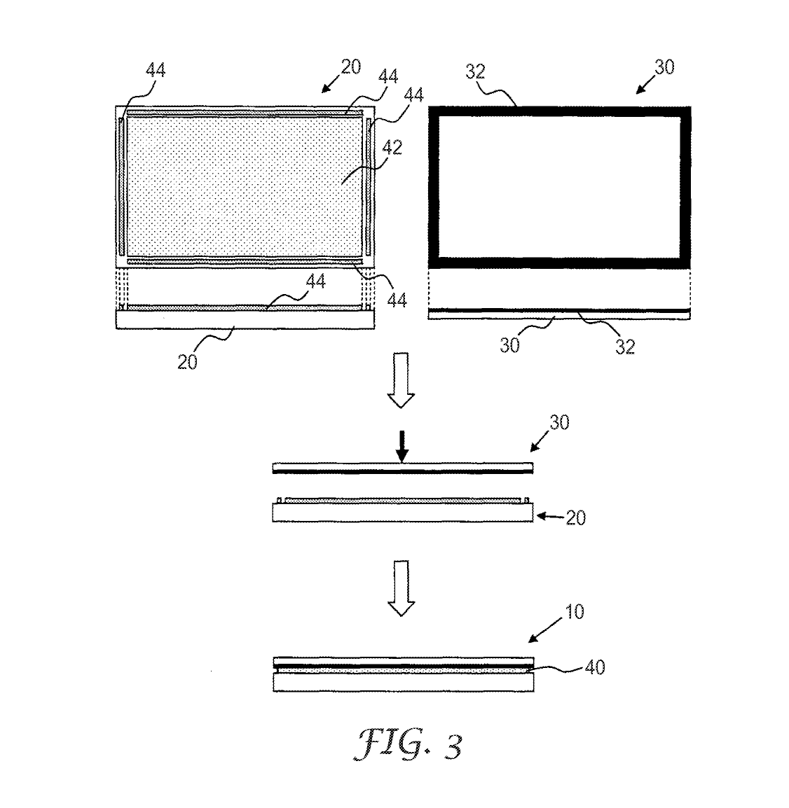

In the above embodiment, for example, the first composition and the second composition may be pattern-coated as schematically shown in FIG. 3. In this case, second composition 44 is applied to the periphery region of the image display surface of image display device 20, corresponding to light-shielding portion 32 of translucent protective material 30, by dispensing, slot die or the like. First composition 42 further containing a photopolymerization initiator is applied to at least a portion of the interior surface region defined by the second composition, excluding the portion applied with the second composition, e.g. in a rectangular shape, by slot die, printing or the like (left side, top diagram of FIG. 3; the upper is plan view and the lower is side view). The pattern in which the first composition and the second composition are applied is not limited to that shown in FIG. 3, and for example, various continuous or discontinuous geometric patterns capable of effectively preventing air bubbles from mixing in LOCA can be used. In addition, the objects or regions to which the first composition and the second composition are applied may be in various combinations. More specifically, including the embodiment shown in FIG. 3, either one of the first composition and the second composition may be applied to a region corresponding to the light-shielding portion, on either one of the image display surface of the image display unit and the translucent protective material, and the other composition may be applied to at least a portion of the region excluding the portion to which the above composition is applied, on either one of the image display surface of the image display unit and the translucent protective material.

Next, image display unit 20 and translucent protective material 30 are positioned by arranging the image display surface, that is, the surface applied with first composition 42 and second composition 44, of image display unit 20 to face the surface of translucent protective material 30, that is, in FIG. 3, the surface in which light-shielding portion 32 is formed by printing or the like (the middle diagram of FIG. 3, side view). FIG. 3 shows how image display unit 20 and translucent protective material 30 are aligned and translucent protective material 30 is gradually lowered so that first composition 42 can be spread from the center to the outside of translucent protective material 30 to come into contact with peripherally-located second composition 44. By this procedure, first composition 42 and second composition 44 are contacted and at least partially mixed. In this way, LOCA 40 is disposed between the image display surface of image display unit 20 and translucent protective material 30 (the lower diagram of FIG. 3, side view).

After contacting image display unit 20 and translucent protective material 30, as shown in FIG. 3, light irradiation is performed by means of a general ultraviolet irradiation apparatus using a light source having a wavelength distribution in the photosensitive wavelength region of the photopolymerization initiator. Light sources include low-pressure mercury lamp, medium-pressure mercury lamp, high-pressure mercury lamp, ultrahigh-pressure mercury lamp, xenon lamp, metal halide lamp and electrodeless lamp. The ultraviolet irradiation dose is generally from about 500 mJ/cm² to about 6,000 mJ/cm². Upon this light irradiation, the photopolymerization initiator contained in the first composition decomposes to produce an active radical, and LOCA in the light-irradiated portion is rapidly cured. In other portions where the first composition and the second composition are at least partially mixed, redox polymerization proceeds in parallel, and therefore LOCA in the region corresponding to the light-shielding portion is cured by redox polymerization. In this embodiment, both photopolymerization and redox polymerization are utilized, whereby LOCA can achieve uniform adhesion over the entire applied region including the region corresponding to the light-shielding portion. Furthermore, in this embodiment, even when the reducing agent contained in the second composition has high colorability, such a reducing agent can be used by applying the second composition to the region corresponding to the light-shielding portion, i.e., the region unseen from the outside.

The thickness of LOCA after curing can be determined to be large enough to adhere the image display unit with the translucent protective material. For example, each of the first composition and second composition may be applied so that the thickness of LOCA after curing can be from about 50 μm to about 400 μm, and each of the first composition and the second composition can be applied to a thickness of, for example, from about 50 μm to about 400 μm.

### EXAMPLES

### Abbreviations of Materials Used in Examples

AA: acrylic acid

LA: lauryl acrylate

2-EHA: 2-ethylhexyl acrylate

NK Ester AM-90G: methoxypolyethylene glycol 400 acrylate (produced by Shin-Nakamura Chemical Co., Ltd.)

4-HBA: 4-hydroxybutyl acrylate

NK Ester A-400: polyethylene glycol 400 diacrylate (produced by Shin-Nakamura Chemical Co., Ltd.)

V-190: ethoxyethoxyethyl acrylate (produced by Osaka Organic Chemical Industry Ltd.)

Light Ester P-1M: 2-methacryloyloxyethyl acid phosphate (produced by Kyoeisha Chemical Co., Ltd.)

Paracron SN-50: acryl polymer (produced by Negami Chemical Industrial Co., Ltd.)

SR489D: tridecyl acrylate (produced by Sartomer)

Bisomer PPA6: urethane acrylate (produced by Cognis)

SSM-7: urethane acrylate (produced by Negami Chemical Industrial Co., Ltd.)

SSM-9: urethane acrylate (produced by Negami Chemical Industrial Co., Ltd.)

Pinecrystal KE-311: hydrogenated rosin ester (produced by Arakawa Chemical Industries, Ltd.)

KBM-503: methacryloxypropyltrimethoxysilane (produced by Shin-Etsu Chemical Co., Ltd.)

DOA: bis(2-ethylhexyl) adipate (produced by Shinnihon Chemicals Corp.)

Irgacure (registered trademark) 651: 2,2-dimethoxy-1,2-diphenylethan-1-one (produced by BASF)

Lucirin (registered trademark) TPO-L: ethyl-2,4,6-trimethylbenzoylphenylphosphinate (produced by BASF)

Irganox 1076: octadecyl-3-(3,5-di-tert-butyl-4-hydroxyphenyl) propionate (produced by BASF)

ADEKASTUB A0503: ditridecylthiodipropionate (produced by ADEKA)

PERCUMYL (registered trademark) H-80: cumene hydroperoxide (produced by NOF Corp.)

ET: ethylenethiourea

VO(AcAc)₂: vanadyl acetylacetonate

### Production of Cover Sheet (Protective Material) Having Printing Area

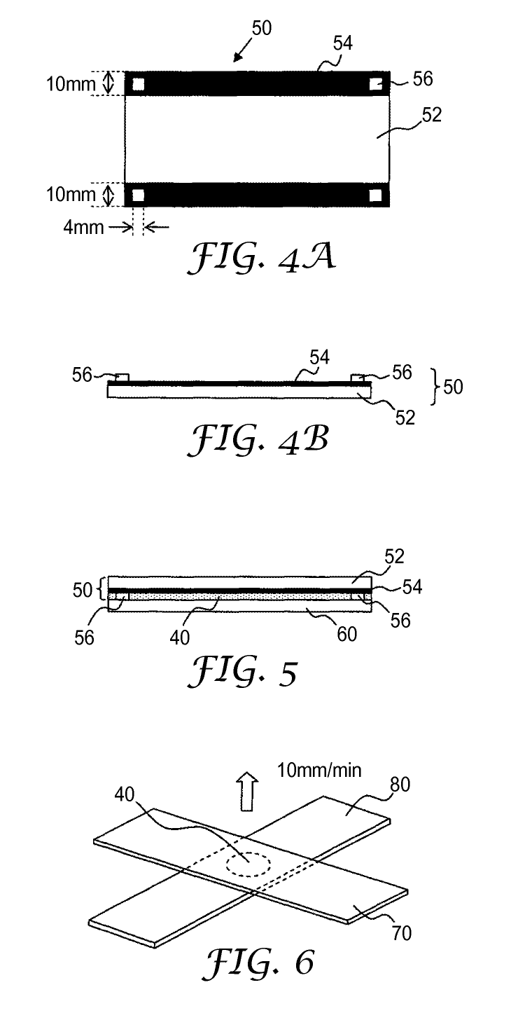

Instead of black printing, black tape (thickness: 65 μm) was attached to each long side of a glass plate (53 mm×100 mm×2 mm). The width of the tape was 10 mm. Subsequently, 3M 8197 Tape (thickness: 175 μm) with a size of 4 mm×4 mm was attached as a spacer to each corner of the glass plate. FIGS. 4A and 4B schematically show the top view and side view, respectively, of produced cover sheet 50, where black tape 54 is attached to glass plate 52 and spacer 56 is attached thereon.

### Production of Release-Treated Glass Plate

A glass plate (53 mm×100 mm×2 mm) was release-treated using EGC-1720 (available under the trade designation 3M NOVEC Electronic Coating EGC-1720 from the 3M Company, St. Paul, Minn., U.S.A.). First, the glass plate was dipped in EGC-1720 for a few seconds, then placed in an oven at 100° C. for 30 minutes, and finally rinsed with HFE-7200 (available under the trade designation 3M NOVEC Engineered Fluid HFE-7200, from 3M Company, St. Paul, Minn., U.S.A.) to obtain a release-treated glass plate. The release-treated surface of this release-treated glass plate is simulating the image display surface of the image display unit in this disclosure.

### Example 1

LOCA was prepared by the following process. First, 50 parts by mass of LA, 30 parts by mass of NK Ester AM-90G, 20 parts by mass of 4-HBA, and 0.04 parts by mass of Irgacure (registered trademark) 651 were mixed in a glass flask, and the mixture was partially photopolymerized using a low-pressure ultraviolet light source under nitrogen purging to obtain a viscous syrup (about 1,000 mPa·s). Next, 20 parts by mass of the obtained syrup, 0.2 parts by mass of NK Ester A-400 and 0.8 parts by mass of PERCUMYL (registered trademark) H-80 were mixed to prepare Liquid Composition 1A. Separately, 20 parts by mass of the obtained syrup, 0.2 parts by mass of NK Ester A-400 and 0.05 parts by mass of ET were mixed to prepare Liquid Composition 1B. Liquid Compositions 1A and 1B were degassed and then filled in a two-part cartridge (mixing ratio: 1:1). Subsequently, a mixing nozzle was fixed to the cartridge, and LOCA resulting from mixing of Liquid Compositions 1A and 1B was dispensed on a release-treated glass plate (53 mm×100 mm×2 mm). The cover sheet produced above was laminated to the glass plate by positioning the surface of the cover sheet having the black tape with spacer to face the LOCA coated glass plate surface and contacting the cover sheet surface to the LOCA. FIG. 5 schematically shows the side view of cover sheet 50, release-treated glass plate 60 and LOCA 40 disposed therebetween.

Finally, for the purpose of comparison with an Comparative Example, aluminum tape for blocking light that is transmitted through the black tape was attached to the glass plate along the black tape. Furthermore, the entire end face was covered with aluminum tape. After 15 minutes, the aluminum tape and the release-treated glass sheet were peeled off, and the surface of LOCA was observed with an eye.

### Comparative Example 1

20 Parts by mass of the syrup prepared in Example 1, 1 part by mass of NK Ester A-400 and 2.5 parts by mass of Lucirin (registered trademark) TPO-L were mixed. The obtained mixture was degassed and then dispensed on a release-treated glass plate (53 mm×100 mm×2 mm). Subsequently, the cover sheet produced above was laminate thereon in the same manner as in Example 1. Aluminum tape for blocking light that is transmitted through the black tape was attached to the glass plate along the black tape, and the entire end face was covered with aluminum tape.

Subsequently, ultraviolet irradiation was performed using F300S (V-valve, 120 W/cm) manufactured by Fusion UV Systems Japan KK. The ultraviolet energy measured by UV Power Puck II (manufactured by EIT) was 2,693 mJ/cm² (UV-A), 1,018 mJ/cm² (UV-B) and 37 mJ/cm² (UV-C).

After ultraviolet irradiation, the aluminum tape and the release-treated glass plate were peeled off, and the surface of LOCA was observed by eye.

The surface of LOCA in Example 1 utilizing redox polymerization was completely cured, and there was no difference between the translucent region and the region shielded by the black tape. On the other hand, the surface of LOCA in Comparative Example 1 was not completely cured in a part of the region shielded by the black tape, remaining in liquid form. Without being bound by theory, it is thought that this was due to the absence of ultraviolet ray irradiation in this region, and therefore polymerization did not occur.

### Optical Properties

The transmittance and haze of the cured adhesive were evaluated using NDH2000 (manufactured by Nippon Denshoku Industries Co., Ltd.) in accordance with JIS K7136 (ISO 14782) and JIS K7361-1 (ISO 13468-1), respectively. The sample was produced in the same manner as in Example 1 except for not attaching black tape. The results are shown in Table 1.

### Example 2

LOCA was prepared by the following process. First, 15 parts by mass of Paracron SN-50, 68 parts by mass of 2-EHA, 12.75 parts by mass of V-190, 4.25 parts by mass of AA and 0.5 parts by mass of NK Ester A-400 were mixed in a bottle. The viscosity of the mixture was about 1,700 mPa·s. Next, 20 parts by mass of the obtained mixture and 0.8 parts by mass of PERCUMYL (registered trademark) H-80 were mixed to prepare Liquid Composition 2A. Separately, 20 parts by mass of the obtained mixture and 0.05 parts by mass of ET were mixed to prepare Liquid Composition 2B. Liquid Compositions 2A and 2B were degassed and then filled in a two-part cartridge (mixing ratio: 1:1). A sample for evaluation of optical properties was produced in the same manner as in Example 1. The results are shown in Table 1.

### Example 3

LOCA was prepared by the following process. First, 25 parts by mass of SSM-7, 50 parts by mass of SSM-9, 10 parts by mass of LA, 15 parts by mass of Pinecrystal KE-311 and 0.5 parts by mass of KBM-503 were mixed in a bottle. The viscosity of the mixture was about 5,500 mPa·s. Next, 20 parts by mass of the obtained mixture and 0.8 parts by mass of PERCUMYL (registered trademark) H-80 were mixed to prepare Liquid Composition 3A. Separately, 20 parts by mass of the obtained mixture, 0.2 parts by mass of Light Ester P-1M and 0.05 parts by mass of VO(AcAc)₂ were mixed to prepare Liquid Composition 3B. Liquid Compositions 3A and 3B were degassed and then filled in a two-part cartridge (mixing ratio: 1:1). A sample for evaluation of optical properties was produced in the same manner as in Example 1. The results are shown in Table 1.

TABLE 1

| Sample | Transmittance (%)¹⁾ | Haze (%)¹⁾ |
|---|---|---|
| Example 1 | 90.1 | 0.58 |
| Example 2 | 90.1 | 1.31 |
| Example 3 | 89.4 | 0.24 |

¹⁾Glass per se has a transmittance (T) of 90.8%, and a haze of 0.19%.

### Adhesion Test (Tensile Test)

The adhesives of Examples 2 and 3 were evaluated for the adhesive force after curing by a tensile test. The evaluation samples were prepared and tested as follows.

(1) Liquid Compositions 2A and 2B, or Liquid Compositions 3A and 3B, were mixed.

(2) A spacer having a circular hole having a diameter of 20 mm in a sheet having a thickness of 200 μm, the hole being formed by a punching process, was prepared. The spacer was disposed on a polarizer-laminated aluminum plate, so that the circular hole of the spacer is positioned in the center of the polarizer-laminated aluminum plate.

(3) The mixture obtained in (1) was dropped in a predetermined amount to the polarizer-laminated aluminum plate and inside the circular hole of the spacer.

(4) A glass plate was disposed thereon and pressed so as to remove any excess amount of the mixture from the circular hole of the spacer to the outside, thereby filling the circular hole with the mixture. This maintained the mixture in the form of a thin disk having a diameter of 20 mm and a thickness of 200 μm.

(5) The sample was left standing at room temperature over night.

(6) The spacer was cut and removed from the sample.

(7) As shown in FIG. 6, polarizer-laminated aluminum plate 80 was fixed, and glass plate 70 was pulled in the perpendicular direction (in the arrow direction) at a speed of 10 mm/min. Adhesion was measured in Newton per area of a circle having a diameter of 20 mm (N/20 mmφ).

The results are shown in Table 2.

TABLE 2

| Sample | Adhesive Force (N/20 mmφ) |
|---|---|
| Example 2 | 13 |
| Example 3 | 71 |

### Preparation of LOCA of Examples 4 to 6 and Comparative Example 2

LOCA was prepared by the following process. First, 65 parts by mass of SSM-7, 7 parts by mass of SR489D, 3 parts by mass of PPA6, 15 parts by mass of Pinecrystal KE-311, 10 parts by mass of DOA, 0.5 parts by mass of KBM-503, 1 part by mass of Lucirin (registered trademark) TPO-L, 1 part by mass of Irganox 1076 and 1 part by mass of A0503 were mixed in a bottle. The viscosity of the obtained mixture was about 3,000 mPa·s. This mixture was used in Comparative Example 2.

Next, 40 parts by mass of the obtained mixture and 1.6 parts by mass of PERCUMYL (registered trademark) H-80 were mixed to prepare Liquid Composition 4A. Separately, 40 parts by mass of the obtained mixture and 0.1 parts by mass of VO(AcAc)₂ were mixed to prepare Liquid Composition 4B.

### Production of Cover Sheet (Protective Material) Having Printing Area

Instead of black printing, black tape (thickness: 65 μm) was attached to each long side of a glass plate (53 mm×100 mm×2 mm). The width of the tape was 10 mm. Subsequently, 3M 8195 Tape (thickness: 125 μm) with a size of 4 mm×4 mm was attached as a spacer to each corner of the glass plate. FIGS. 4A and 4B schematically show the top view and side view, respectively, of produced cover sheet 50, where black tape 54 is attached to glass plate 52 and spacer 56 is attached thereon.

### Production of Release-Treated Glass Plate

8172J (optically clear adhesive, produced by 3M) was laminated on a glass plate (53 mm×100 mm×2 mm), and Cerapeel MIB (T) (silicone-treated liner, produced by Toray Advanced Film Co., Ltd.) was laminated thereon to obtain a release-treated glass plate. The release-treated surface of this release-treated glass plate is simulating the image display surface of the image display unit in this disclosure.

### Example 4

Liquid Composition 4A was coated on the release-treated glass plate to a thickness of 100 μm, and Liquid Composition 4B was coated on the cover sheet to a thickness of 100 μm. These two substrates were positioned such that the coated surfaces of the substrates faced each other and contacted each other, whereby redox polymerization was started. After 12 hours, the release-treated glass plate was peeled off, and the surface of LOCA was observed by eye, as a result, LOCA was completely cured.

### Example 5

Liquid Composition 4A and Liquid Composition 4B were dispensed on the release-treated glass plate, each in four stripes with a length of about 100 mm and a width of about 3 mm at a stripe-to-stripe distance of about 2 mm, and then the cover sheet was laminated thereon. Upon lamination, Liquid Compositions 4A and 4B were mixed, and redox polymerization was started. After 12 hours, the release-treated glass plate was peeled off, and the surface of LOCA was observed by eye, as a result, LOCA was completely cured.

### Example 6

Liquid Composition 4A was coated only on the region of the release-treated glass plate, corresponding to the translucent region of the cover sheet, and Liquid Composition 4B was dispensed only in the region of the release-treated glass plate, corresponding to the light-shielding portion (the portion attached with a black tape) of the cover sheet. Thereafter, the cover sheet was laminated thereon and upon lamination, Liquid Composition 4A spread to below the light-shielding portion. In this portion, Liquid Compositions 4A and 4B were mixed, and redox polymerization was started. In order to cure Liquid Composition 4A in the translucent region, ultraviolet irradiation (2 J/cm²) was performed using F300S (H-valve, 120 W/cm) manufactured by Fusion UV Systems Japan KK. After 12 hours, the release-treated glass plate was peeled off, and the surface of LOCA was observed by eye, as a result, LOCA was completely cured.

### Comparative Example 2

The mixture for this Comparative Example was dispensed on the release-treated glass plate, and the cover sheet was laminated thereon. Ultraviolet irradiation (2 J/cm²) was performed using F300S (H-valve, 120 W/cm) manufactured by Fusion UV Systems Japan KK to produce a comparative sample. The release-treated glass plate was peeled off, and the surface of LOCA was observed with an eye, as a result, the surface of LOCA was not completely cured and LOCA below the light-shielding portion remained in liquid form. Without being bound by theory, it is thought that this was due to the absence of ultraviolet ray irradiation in a region below the light-shielding portion, and therefore polymerization did not occur.

1. A method for manufacturing an image display device, comprising:
providing an image display unit having an image display surface;
providing a translucent protective material having a light-shielding portion;
disposing a liquid optically clear adhesive between the image display surface of the image display unit and the translucent protective material; and
curing the liquid optically clear adhesive to adhere the image display unit with said translucent protective material,
wherein the liquid optically clear adhesive is a two-part redox-type adhesive composed of:
a first composition comprising a first base agent containing a compound having at least one ethylenically unsaturated group and a polymerization initiator; and
a second composition comprising a second base agent containing a compound having at least one ethylenically unsaturated group and a reducing agent capable of decomposing said polymerization initiator.

2. The method of claim 1, wherein the compound having at least one ethylenically unsaturated group is selected from the group consisting of: a (meth)acrylic monomer, a (meth)acrylic oligomer and a (meth)acrylic polymer.

3. The method of claim 1, wherein the polymerization initiator is an organic peroxide.

4. The method of claim 1, wherein the reducing agent is selected from the group consisting of: an organic amine, an organic thiourea, an organic acid metal salt, an organic metal chelate compound and a mixture thereof.

5. The method of claim 1, wherein at least one of the first composition and the second composition contains a photopolymerization initiator.

6. The method of claim 5, wherein curing a liquid optically clear adhesive contains a photopolymerization reaction.

7. The method of claim 1, wherein the viscosity of the first composition and the second composition is from 100 to 10,000 mPa·s when measured at 25° C. and a shear rate of 1 second⁻¹.

8. The method of claim 1, wherein the first base agent and the second base agent are the same.

9. The method of claim 1, wherein disposing the liquid optically clear adhesive includes applying either one of the first composition and the second composition to the image display surface of the image display unit, applying the other composition to the translucent protective material, and positioning the image display surface of the image display unit and the translucent protective material to face each other, thereby at least partially mixing the first composition and the second composition.

10. The method of claim 2, wherein disposing the liquid optically clear adhesive includes alternately disposing the first composition and the second composition in a striped fashion between the image display surface of the image display unit and the translucent protective material, and positioning the image display surface of the image display unit and the translucent protective material to face each other, thereby at least partially mixing the first composition and the second composition.

11. The method of claim 1, wherein disposing the liquid optically clear adhesive includes applying either one of the first composition and the second composition to the region corresponding to the light-shielding portion on either one of the image display surface of the image display unit and the translucent protective material, applying the other composition to at least a portion of the region excluding the portion to which the composition is applied on either one of the image display surface of the image display unit and the translucent protective material, and positioning the image display surface of the image display unit and the translucent protective material to face each other, thereby at least partially mixing the first composition and the second composition.
